(19) United States
(12) Patent Application Publication
(10) Pub. No.: US 2008/0052998 A1
(43) Pub. Date: Mar. 6, 2008

(54) Grace door

(76) Inventor: Charles Bingham, Macomb, MI (US)

Correspondence Address: REISING, ETHINGTON, BARNES, KISSELLE, P.C., P O BOX 4390, TROY, MI, 48099-4390, US

(21) Appl. No.: 11/512,972

(22) Filed: Aug. 30, 2006

(51) Int. Cl. E05B 65/06

(52) U.S. Cl. 49/394

(57) ABSTRACT

One embodiment may include an escape door assembly comprising a frame and a door. The frame being installed in an opening in a floor near a pair of floor joists. The door covering and uncovering the floor's opening to allow egress through the floor.

### TECHNICAL FIELD

The disclosure generally relates to escape door assemblies that provide egress through the assemblies and that may be installed in floors.

### BACKGROUND

Some living spaces in a home have limited exits that can become blocked by a fire or similar emergency. Basements, for instance, are commonly set below ground level with little or no exits to the outside, and with only one set of stairs to a main floor.

### SUMMARY OF EXEMPLARY EMBODIMENTS OF THE INVENTION

One embodiment of the invention may include an escape door assembly comprising a frame and a door. The frame may be installed in an opening in a floor and may be partly supported by a pair of floor joists. The door may move between a closed position and an open position to allow egress therethough.

Another embodiment of the invention may include a product comprising a frame, a door, and a latch. The frame may be constructed for installation in a floor and may include at least one cross-support and at least one side-support. The door may be constructed to partly rest on the frame and the latch may be partly attached to the door.

Another embodiment of the invention may include a method comprising providing an opening in a floor, mounting a frame in the opening, and hinging a door to the floor.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a top perspective view of an escape door assembly according to one embodiment of the invention, showing the assembly installed in a floor.

FIG. 2 is a bottom view of the escape door assembly of FIG. 1.

FIG. 3 is a side perspective view of the escape door assembly of FIG. 1, showing a door in an open position.

FIG. 4 is a bottom perspective view of the escape door assembly of FIG. 1.

FIG. 5 is a sectional view taken along line 5-5 of FIG. 4 of the escape door assembly of FIG. 1.

FIG. 6 is a sectional view taken along line 6-6 of FIG. 4 of the escape door assembly of FIG. 1.

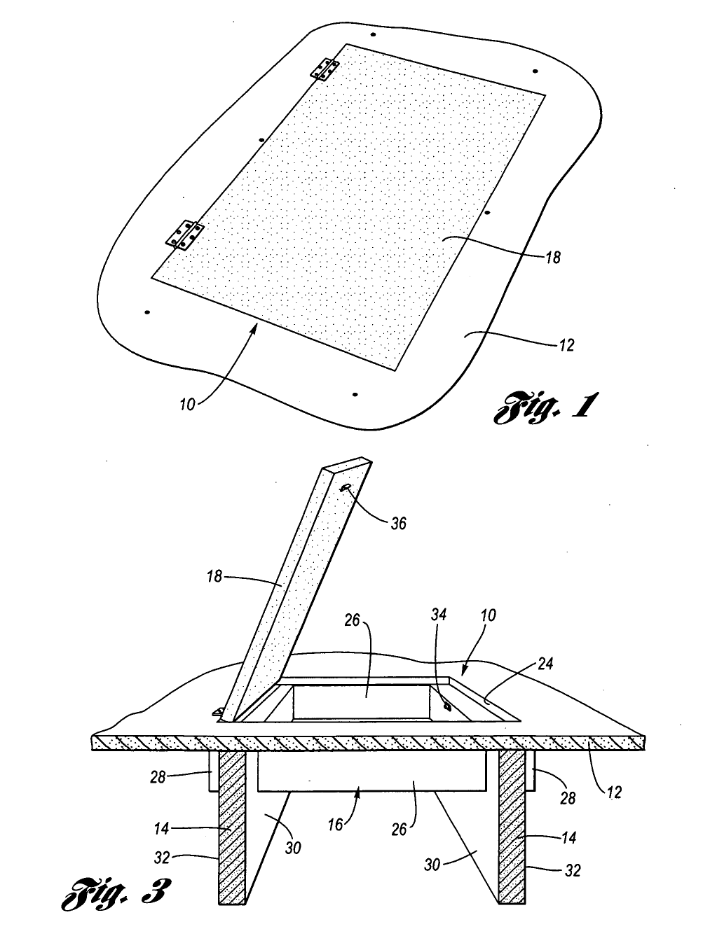

### DETAILED DESCRIPTION OF EXEMPLARY EMBODIMENTS

The following description of the embodiment(s) is merely exemplary in nature and is in no way intended to limit the invention, its application, or uses.

The figures illustrate an embodiment of an escape door assembly 10 that may be installed in a floor 12, such as a main floor located directly above a basement in a home. In some cases the escape door assembly 10 may be installed in such a main floor adjacent a closet, a pantry, or the like where it may be used as an egress for a person exiting the basement in case of a fire or similar emergency. In these cases, it may be installed near a pair of parallel 2″×10″ floor joists 14 (wooden or otherwise) that may be spaced 15″, 16″ or 18″ apart to provide structural support for the floor 12—and it may be either retrofitted in an existing floor construction or as part of a new floor construction. The escape door assembly may comprise a frame 16, a door 18, a latch 20, and a ladder.

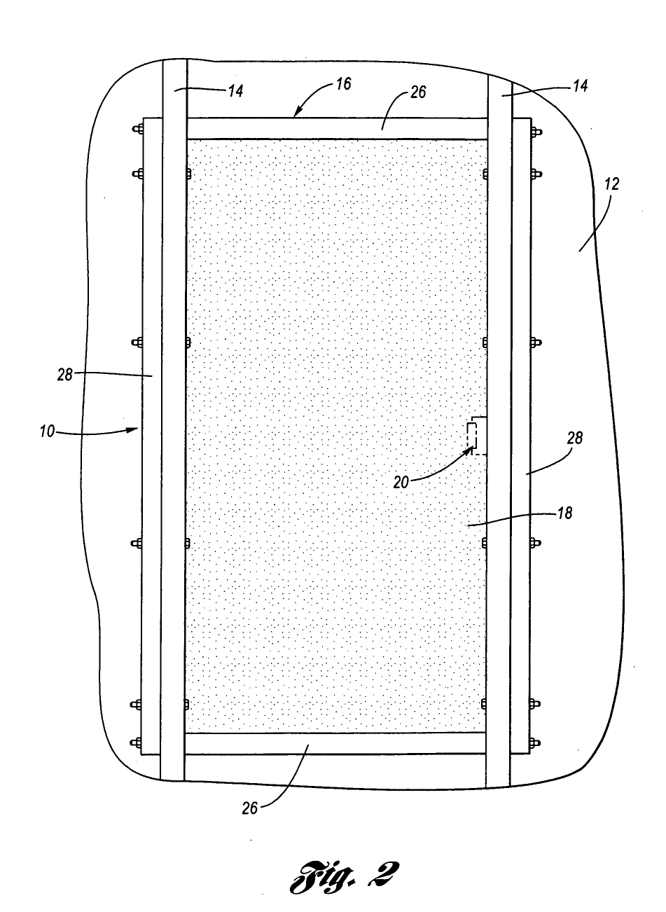

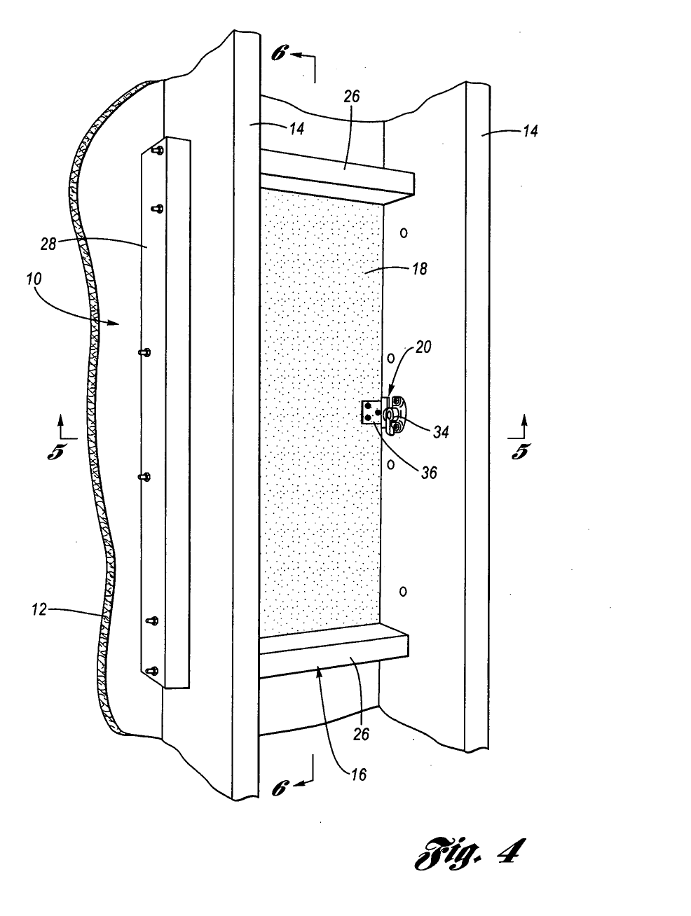

Referring to FIGS. 2-6, the frame 16 is constructed for installation in a generally rectangular opening 24 in the floor 12 to provide the general framework of the escape door assembly 10 and to partly support the door 18. The frame 16 may have a rectangular shape to complement the opening 24, but both may be shaped as a square, oval, or the like. It may sit below the floor 12 to be supported by the floor joists 14. In particular, the frame 16 may be installed around the floor joists 14 such as in the embodiment shown with a pair of cross-supports 26 and a pair of side-supports 28. The cross-supports 26 define opposite sides of the frame 16 and may provide resting surfaces for the door 18. They may be 2″×4″s made out of a variety of materials including, but not limited to wood, metal, composite or polyethylene. When installed, the cross-supports 26 may extend perpendicularly between inner surfaces 30 of the floor joists 14, the cross-supports thus having a length to fit between 15″, 16″ or 18″ centered joists. The cross-supports 26 may be mounted to the floor joists 14 to be spaced parallel with respect to each other and may have their resting surfaces flush with the top surface of the floor joists 14. The side-supports 28 also define opposite sides of the frame 16 and may provide additional support for the floor 12 and the escape door assembly 10. They may be 2″×4″s made out of a variety of materials including, but not limited to, wood, metal, composite or polyethylene. The side-supports 28 may be mounted parallel with the floor joists 14 and along outer surfaces 32 of the floor joists 14. Each side-support 28 may be on its longest side at least 50%, or 50-125% of the length of the longest side of a door to rest thereon. Further, one of the side-supports 28—that is the one adjacent a hinge on the door 18—may be positioned lower on the respective floor joist 14 vertically away from the floor 12 such that when the door is swung open, that side-support 28 does not interfere with the door's movement. Along these lines, the one side-support 28 may be channeled on the particular side facing the hinge so as to also prevent interference when the door 18 is swung open. The cross-supports 26 and the side supports 28 may each be mounted to the floor joist(s) 14 by bolts, screws, nails, one or more brackets, an adhesive or the like. In other embodiments, the frame 16 may not include the cross-supports 26 or the side-supports 28, or may include either one pair or the other, or may even include only one cross-support 26 and only one side-support 28.

Referring to all the Figs., the door 18 may be hinged to floor 12 to move manually between an open position where the door 18 covers the opening 24, and a closed position where the door 18 uncovers the opening 24. The door 18 may have a rectangular shape to complement the opening 24 and the frame 16, or another shape as discussed above. The door 18 may be made out of a variety of materials including, but not limited to, wood metal, composite, or plastic (thermoplastic or thermoset) such as polycarbonate or polyethylene, (such as high density polyethylene). The door 18 may have a planar first face 19 that faces the home basement when the door 18 is in the closed position, and the door 18 may also have a second face 21 that faces above the floor 12 when the door 18 is in the closed position. In one embodiment, the second face 21 may not have a handle or any other means to open the door 18 from the other side 19. Here, the door 18 could only open from the first face 19 by pushing upward on the first face 19. The door 18 may fit in the opening 24 and may be flush with the top surface of the floor 12 when in the closed position, where it may rest partly on the cross-supports 26 and partly on the floor joists 14. In other embodiments, the door 18 may not be hinged and instead may simply lift up and off of the opening 24. And in other embodiments, the door 18 may be constructed with an automated device to automatically (instead of manually) open and close it. Still, the door 18 may be flush with the floor 12 as mentioned, or it may sit slightly raised above the floor 12; in either case, the second face 21 may be fitted with a carpeted or finished wooden surface to match the floor 12. And if the floor 12 is already covered with carpeting, the door 18 may be installed near an edge of the carpeting where the carpeting would be slit and unattached in such a way to allow the door 18 to swing open and displace the carpeting.

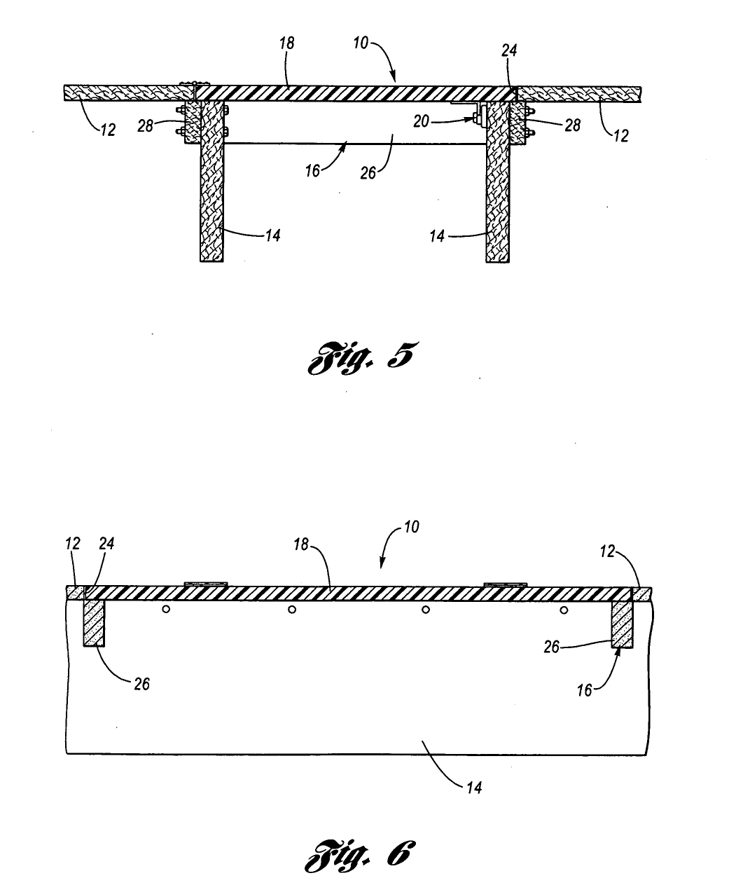

Referring to FIGS. 2-5, the latch 20 may be constructed to secure the door 18 in the closed position. Such latching can be done in a number of ways including one with a swing 34 and a hook 36 as shown. Both may be located below the floor 12 where the latch 20 can be accessed by a person below the floor 12. The swing 34 may be attached by bolting to one inner surface 30, while the hook 36 may be attached by bolting to the first face 19 of the door 18. In use, the swing 34 manually pivots to capture the hook 36 to thus secure the door 18 as shown particularly in FIG. 5. Other embodiments may include latches of various types to secure the door 18, or may not include a latch at all where the door 18 would simply rest in the closed position.

The ladder may be installed to facilitate egress through the escape door assembly 10. A number of suitable ladders can be used including one pivotally mounted and stowable between the floor joists 14, and extendable below the opening 24. In other embodiments, the ladder may be of the retractable type, the foldable type, the rope type, or the like—all types that are generally known to those skilled in the art. For example, suitable ladders may include the one disclosed in U.S. Pat. No. 6,994,184 issued to Latimer et al. And still in other embodiments, the ladder need not be included in the escape door assembly 10.

Installing various embodiments may be accomplished by a number of methods including, but not limited to, providing the opening 24 by cutting (existing floor) or leaving (new floor) an opening. The size of the opening may, for example, correspond to floor joists that are 15″, 16″ or 18″ centered joists. For example, an opening for 16″ centered joists may measure about 19″×30″ in the floor 12. This way the opening 24 may be positioned to extend beyond the floor joists 14, for example, by 1″ on at least one side, and preferably on both sides. The opening 24 may extend completely vertically through the floor 12 to expose a section of each floor joist 14. The frame 16 may then be mounted to the floor joists 14 as earlier described—in short, the cross-supports 26 may be mounted to inner surfaces 30 and the side-supports 28 may be mounted to outer surfaces 32. The door 18 may then be hinged to the floor 12 as also described earlier. In this particular method, the door 18 would measure about 19″×30″ so that the door 18 fits in the opening 24. Again, when the door 18 is in the closed position, it may rest flush with the floor 12 to blend in with the floor and may even support a person standing on top of it. The ladder may also be mounted adjacent the floor joists 14 below the opening 24. Once installed, a person can use the ladder to climb up to the escape door assembly 10, unlatch the door 18, swing open the door 18 to the open position, and then escape through the opening 24.

Another embodiment of the invention includes a kit for installing the escape door assembly 10 in the floor 12. The kit may comprise the frame 16 with at least one cross-support 26 and at least one side-support 28 and the door 18. The cross-support 26 may have a preselected length to fit between and be mounted to 15″, 16″ or 18″ centered joists. The kit may further comprise a mounting means for the cross-support 26 and side support 28, latch 20 and/or the ladder.

The above description of embodiments of the invention is merely exemplary in nature and, thus, variations thereof are not to be regarded as a departure from the spirit and scope of the invention.

What is claimed is:

1. An escape door assembly comprising:
a frame installed in an opening in a floor that is located directly above a basement, the frame being at least partly supported by a pair of floor joists; and
a door movable between a closed position where the door covers the opening, and an open position where the door uncovers the opening to allow egress therethrough.

2. An assembly as set forth in claim 1 wherein the frame comprises:
a pair of spaced cross-supports, each one extending perpendicularly between the inner surfaces of the pair of floor joists; and
a pair of side-supports, each one mounted parallel along the outer surfaces of the pair of floor joists.

3. An assembly as set forth in claim 2 wherein the opening is generally defined by the cross-supports and the pair of floor joists.

4. An assembly as set forth in claim 1 wherein the door is hinged to the floor such that the door swings up above the floor to the open position.

5. An assembly as set forth in claim 4 wherein the door is planar, and when in the closed position rests partly on the pair of floor joists and lies flush with the top surface of the floor.

6. An assembly as set forth in claim 1 wherein the door has a first face that, when the door is in the closed position, faces the basement, and a second face opposite the first face that, when the door is in the closed position, faces above the floor, the assembly further comprising a latch partly attached to the first face to secure the door in the closed position.

7. An assembly as set forth in claim 6 wherein the latch comprises a swing attached to the inner surface of one of the pair of floor joists and a hook attached to the bottom surface of the door, whereby the swing manually captures the hook to thus secure the door.

8. An assembly as set forth in claim 6 wherein the second face does not have a handle such that the door can only be opened from the first face.

9. An assembly as set forth in claim 1 further comprising a ladder installed adjacent to the pair of floor joists, the ladder extending below the opening to facilitate egress through the opening.

10. A product comprising:
a frame constructed for installation in a floor, the frame comprising at least one cross-support having a preselected length to fit between and be mounted to 15″, 16″ or 18″ centered joists, and at least one side-support having a length that is at least half of the longest side of a door to rest thereon; and
a door constructed to at least partly rest on the frame.

11. A product as set forth in claim 10 further comprising a ladder constructed for mounting adjacent the frame.

12. A product as set forth in claim 10 wherein both the at least one cross-support and side-support comprise wood.

13. A product as set forth in claim 12 wherein the door is planar and comprises wood.

14. A product as set forth in claim 10 wherein the latch includes a swing and a hook attached to the first face of the door.

15. A product as set forth in claim 10 wherein the frame is constructed for installation in a floor that is directly above a home basement.

16. A product as set forth in claim 10 further comprising a latch to be at least partly attached to the door.

17. A product as set forth in claim 10 further comprising a means for mounting at least one of the cross-support or side-support to a joist.

18. A method comprising:
providing an opening in a floor to expose a pair of parallel floor joists below, the floor lying directly over a basement;
mounting a frame to the pair of parallel floor joists; and
hinging a door to the floor such that when the door is closed the door covers the opening, and when the door is open the door uncovers the opening to allow egress therethrough.

19. A method as set forth in claim 18 further comprising mounting a first cross-support perpendicularly between the pair of floor joists, and mounting a second cross-support perpendicularly between the pair of floor joists and spaced away from the first cross-support.

20. A method as set forth in claim 18 further comprising mounting a first side-support parallel along the outer surface of one of the pair of floor joists, and mounting a second side-support parallel along the outer surface of the other of the pair of floor joists.

21. A method as set forth in claim 18 further comprising latching the door closed with a latch accessible from below the floor.

22. A method as set forth in claim 18 further comprising mounting a ladder adjacent the pair of floor joists below the opening to facilitate egress through the opening.
